(19) United States
(12) Patent Application Publication
(10) Pub. No.: US 2026/0214675 A1
(43) Pub. Date: Jul. 23, 2026

(54) METHOD AND APPARATUS OF SMALL DATA TRANSMISSION USING CONFIGURED RESOURCES BY REDUCED CAPABILITY UE IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Jaehyuk JANG, Suwon-si (KR)

(21) Appl. No.: 19/137,518

(22) PCT Filed: Dec. 27, 2023
(86) PCT No.: PCT/KR2023/021718

§ 371 Date: Jun. 10, 2025

(30) Foreign Application Priority Data
Jan. 4, 2023 (KR) 10-2023-0001305

(51) Int. Cl. H04W 72/21; H04W 74/0833; H04W 76/27

(52) U.S. Cl. CPC H04W 72/21; H04W 74/0833; H04W 76/27

(57) ABSTRACT

The disclosure relates to a 5G or 6G communication system for supporting a higher data transmission rate. Specifically, the present disclosure provides method and apparatus for SDT procedures using configured resources in wireless communication system. According to various embodiments of the disclosure, SDT procedures using configured resources (or, configured grant resources) can be efficiently enhanced for UE.

### DESCRIPTION

### Technical Field

The disclosure relates to a wireless communication system (or a mobile communication system). Specifically, the disclosure relates to an apparatus, a method and a system for small data transmission (SDT) using configured resources (or, configured grant resources) by reduced capability (RedCap) terminal in wireless communication system.

### Background Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Recently, there are needs to enhance small data transmission procedures with respect to configured resources.

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, a radio resource control (RRC) release message including suspend configuration, the RRC release message including information on a configured grant (CG) resource for a small data transmission (SDT); identifying an uplink carrier for an SDT data based on an SDT criteria being met; identifying a SDT procedure for the SDT data among a CG-SDT procedure and a random access (RA)-SDT procedure; and transmitting, to the base station, the SDT data on the uplink carrier according to the SDT procedure.

In accordance with another aspect of the disclosure, a terminal is provided. The terminal comprises: a transceiver; and a controller coupled with the transceiver and configured to: receive, from a base station, a radio resource control (RRC) release message including suspend configuration, the RRC release message including information on a configured grant (CG) resource for a small data transmission (SDT), identify an uplink carrier for an SDT data based on an SDT criteria being met, identify a SDT procedure for the SDT data among a CG-SDT procedure and a random access (RA)-SDT procedure, and transmit, to the base station, the SDT data on the uplink carrier according to the SDT procedure.

### Advantageous Effects of Invention

According to various embodiments of the disclosure, SDT procedures using configured resources (or, configured grant resources) can be efficiently enhanced for UE.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of configured grant (CG) SDT procedure in accordance with an embodiment of the disclosure.

FIG. 2 illustrates another example of CG-SDT procedure in accordance with an embodiment of the disclosure.

FIG. 3 illustrates an example of medium access control (MAC) protocol data unit (PDU) and radio network temporary identifier (RNTI) usage in accordance with an embodiment of the disclosure.

FIG. 4 is a block diagram of a terminal according to an embodiment of the disclosure.

FIG. 5 is a block diagram of a base station according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart.

Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as RX beam.

Carrier Aggregation (CA)/Multi-connectivity in fifth generation wireless communication system: The fifth generation wireless communication system, supports standalone mode of operation as well dual connectivity (DC). In DC a multiple Rx/Tx UE may be configured to utilize resources provided by two different nodes (or base stations) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in radio resource control (RRC) connected (RRC_CONNECTED) is configured to utilize radio resources provided by two distinct schedulers, located in two different nodes connected via a non-ideal backhaul and providing either Evolved Universal Mobile Telecommunications System (UMTS) Terrestrial Radio Access (E-UTRA) (i.e., if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell (SpCell). PSCell refers to a serving cell in SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

PDCCH in fifth generation wireless communication system: In the fifth generation wireless communication system, Physical Downlink Control Channel (PDCCH) is used to schedule downlink (DL) transmissions on physical downlink shared channel (PDSCH) and uplink (UL) transmissions on physical uplink shared channel (PUSCH), where the Downlink Control Information (DCI) on PDCCH includes: Downlink assignments containing at least modulation and coding format, resource allocation, and hybrid automatic repeat request (HARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmission power control (TPC) commands for PUCCH and PUSCH; Transmission of one or more TPC commands for sounding reference signal (SRS) transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations are signaled by GNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’satisfies the equation below:

$$y * ( number of slots in a radio frame ) + x - Monitoring - offset - PDCCH - slot ) mod ( Monitoring - Periodicity - PDCCH - slot ) = 0 ;$$

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations are signaled by GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL reference signal (RS) identifier (ID) (synchronization signal and physical broadcast channel block (SSB) or channel state information reference signal (CSI-RS)) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is quasi-collocated (QCLed) with SSB/CSI-RS of TCI state) used by GNB for transmission of PDCCH in the PDCCH monitoring occasions of a search space.

BWP operation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the medium access control (MAC) entity itself upon initiation of Random Access procedure. Upon addition of SpCell or activation of an SCell, the DL BWP and UL BWP indicated by firstActiveDownlinkBWP-Id and firstActiveU-plinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, RRC connection re-establishment procedure, scheduling request transmission, secondary cell group (SCG) addition/modification, beam failure recovery and data or control information transmission in UL by non-synchronized UE in RRC CONNECTED state.

Contention based random access (CBRA): This is also referred as 4 step CBRA. In this type of random access, UE first transmits Random Access preamble (also referred as Msg1) and then waits for RAR in the RAR window. RAR is also referred as Msg2. GNB transmits the RAR on PDSCH. PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH TX occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by gNB can be multiplexed in the same RAR MAC protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step i.e. select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e. cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives PDCCH addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e. select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for SCell, etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to CBRA procedure. CFRA is considered successfully completed after receiving the RAR including RAPID of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e. during random access resource selection for Msg1 transmission UE determines whether to transmit dedicated preamble or non dedicated preamble. Dedicated preambles are typically provided for a subset of SSBs/CSI-RSs. If there is no SSB/CSI RS having DL reference signal received power (RSRP) above a threshold amongst the SSBs/CSI-RSs for which contention free random access resources (i.e. dedicated preambles/ROs) are provided by gNB, UE select non dedicated preamble. Otherwise, UE select dedicated preamble. Thus, during the RA procedure, one random access attempt can be CFRA while other random access attempt can be CBRA.

2 step contention based random access (2 step CBRA): In the first step, UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e. gNB) within a configured window. The response is also referred as MsgB. GNB transmits the MsgB on PDSCH. PDCCH scheduling the PDSCH carrying MsgB is addressed to MsgB-radio network temporary identifier (MSGB-RNTI). MSGB-RNTI identifies the time-frequency resource (also referred as PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14*80*8*2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e. upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure i.e. UE only transmits the PRACH preamble.

MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding. MsgA may include UE ID (e.g. random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g. in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case gNB assigns to UE dedicated Random access preamble(s) and PUSCH resource(s) for MsgA transmission. RO(s) to be used for preamble transmission may also be indicated. In the first step, UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. The response is also referred as MsgB.

GNB) transmits the MsgB on PDSCH. PDCCH scheduling the PDSCH carrying MsgB is addressed to MSGB-RNTI. MSGB-RNTI identifies the time-frequency resource (also referred as PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14*80*8*2, where s_id is the index of the first orthogonal frequency division multiplexing (OFDM) symbol of the PRACH occasion where UE has transmitted Msg1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e. during random access resource selection for MsgA transmission UE determines whether to transmit dedicated preamble or non dedicated preamble. Dedicated preambles is typically provided for a subset of SSBs/CSI-RSs. If there is no SSB/CSI-RS having DL RSRP above a threshold amongst the SSBs/CSI-RSs for which contention free random access resources (i.e. dedicated preambles/ROs/PUSCH resources) are provided by gNB, UE select non dedicated preamble. Otherwise, UE select dedicated preamble. Thus, during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signalled by gNB, UE select the signalled carrier for performing Random Access procedure. If the carrier to use for the Random Access procedure is not explicitly signalled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure. UE then determines whether to perform 2 step or 4 step RACH for this random access procedure.

If this random access procedure is initiated by PDCCH order and if the ra-PreambleIndex explicitly provided by PDCCH is not Ob000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
   if RSRP of the downlink pathloss reference is below a configured threshold, UE selects 4 step RACH. Otherwise UE selects 2 step RACH.

In the 5th generation (also referred as NR or New Radio) wireless communication system UE can be in one of the following RRC state: RRC IDLE, RRC INACTIVE and RRC CONNECTED. The RRC states can further be characterized as follows:

In RRC_IDLE state, a UE specific discontinuous reception (DRX) may be configured by upper layers (i.e., non-access stratum (NAS)). The UE, monitors Short Messages transmitted with paging RNTI (P-RNTI) over DCI; Monitors a Paging channel for CN paging using 5G-S-TMSI; —Performs neighboring cell measurements and cell (re-)selection; Acquires system information and can send SI request (if configured).

In RRC_INACTIVE state, a UE specific DRX may be configured by upper layers or by RRC layer; In this state, UE stores the UE Inactive AS context. A RAN-based notification area is configured by RRC layer. The UE monitors Short Messages transmitted with P-RNTI over DCI; Monitors a Paging channel for CN paging using 5G-S-TMSI and RAN paging using fullI-RNTI; Performs neighboring cell measurements and cell (re-)selection; Performs RAN-based notification area updates periodically and when moving outside the configured RAN-based notification area; Acquires system information and can send SI request (if configured).

In the RRC_CONNECTED, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighboring cell measurements and measurement reporting; Acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the User Plane Function (UPF) by means of the NG-U interface. In the 5th generation (also referred as NR or New Radio) wireless communication system, the UE may use DRX in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using PDSCH. PDCCH is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e. the Synchronization Signal and physical broadcast (PBCH) block (SSB) consists of primary and secondary synchronization signals (PSS, SSS) and PBCH) in cell. UE first determines the paging frame (PF) and then determines the PO with respect to the determined PF. One PF is a radio frame (10 ms).

Small data transmission in fifth generation wireless communication system: Small Data Transmission (SDT) is a procedure allowing data and/or signaling transmission while remaining in RRC_INACTIVE state (i.e. without transitioning to RRC_CONNECTED state). SDT is enabled on a radio bearer basis and is initiated by the UE only if less than a configured amount of UL data awaits transmission across all radio bearers for which SDT is enabled, the DL RSRP is above a configured threshold, and a valid SDT resource is available.

SDT procedure is initiated with either a transmission over RACH (configured via system information) or over Type 1 CG resources (configured via dedicated signaling in RRCRelease). The SDT resources can be configured on initial BWP for both RACH and CG. RACH and CG resources for SDT can be configured on either or both of NUL and SUL carriers. The CG resources for SDT are valid only within the cell the UE received RRCRelease and transitioned to RRC_INACTIVE state. For RACH, the network can configure 2-step and/or 4-step RA resources for SDT. When both 2-step and 4-step RA resources for SDT are configured, the UE selects the RA type. CFRA is not supported for SDT over RACH.

Once initiated, the SDT procedure is either:
successfully completed after the UE is directed to RRC_IDLE (via RRCRelease) or RRC_INACTIVE (via RRCRelease or RRCReject) or to RRC_CONNECTED (via RRCResume or RRCSetup); or
unsuccessfully completed upon cell re-selection, expiry of the SDT failure detection timer (also referred as T319a), a MAC entity reaching a configured maximum PRACH preamble transmission threshold, an RLC entity reaching a configured maximum retransmission threshold, or expiry of SDT-specific timing alignment timer while SDT procedure is ongoing over CG and the UE has not received a response from the network after the initial PUSCH transmission.

Upon unsuccessful completion of the SDT procedure, the UE transitions to RRC_IDLE.

The initial PUSCH transmission during the SDT procedure includes at least the CCCH message. After the SDT procedure is initiated, UE starts SDT failure detection timer (also referred as T319a) when UE first transmits the MAC PDU including the CCCH message. When using CG resources for initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation (dynamic UL grant or DL assignment) for the initial PUSCH transmission from the network. For subsequent UL transmission, the UE cannot initiate re-transmission over a CG resource.
When using RACH resources, the network can schedule subsequent UL and DL transmissions using dynamic UL grants and DL assignments, respectively, after the completion of the RA procedure.

While the SDT procedure is ongoing, if data appears in a buffer of any radio bearer not enabled for SDT, the UE initiates a transmission of a non-SDT data arrival indication using UEAssistanceInformation message to the network and, if available, includes the resume cause.

SDT procedure over CG resources can only be initiated with valid UL timing alignment. The UL timing alignment is maintained by the UE based on a SDT-specific timing alignment timer configured by the network via dedicated signaling and, for initial CG-SDT transmission, also by DL RSRP of configured number of highest ranked SSBs which are above a configured RSRP threshold. Upon expiry of the SDT-specific timing alignment timer (i.e., cg-SDT-TimeAlignmentTimer), the CG resources are released while maintaining the CG resource configuration.

Logical channel restrictions configured by the network while in RRC_CONNECTED state and/or in RRCRelease message for radio bearers enabled for SDT, if any, are applied by the UE during SDT procedure.

The network may configure UE to apply ROHC continuity for SDT either when the UE initiates SDT in the cell where the UE received RRCRelease and transitioned to RRC_INACTIVE state or when the UE initiates SDT in a cell of its radio access network (RAN) notification area (RNA).

Reduced capability UE support in fifth generation wireless communication system: A RedCap UE has reduced capabilities with the intention to have lower complexity with respect to non-RedCap UEs. It is mandatory for a RedCap UE to support 20 MHz maximum UE channel bandwidth in frequency range 1 (FR1) and 100 MHz in frequency range 2 (FR2). UE features and corresponding capabilities related to UE bandwidths wider than 20 MHz in FR1 or wider than 100 MHz in FR2 are not supported by RedCap UEs.

For a RedCap UE:
The maximum mandatory supported data radio bearer (DRB) number is 8; The mandatory supported packet data convergence protocol (PDCP) sequence number (SN) length is 12 bits while 18 bits being optional; The mandatory supported radio link control (RLC) acknowledged mode (AM) SN length is 12 bits while 18 bits being optional;
1 DL multiple input multiple output (MIMO) layer if 1 Rx branch is supported, and 2 DL MIMO layers if 2 Rx branches are supported. UE features and corresponding capabilities related to more than 2 UE Rx branches and more than 2 DL MIMO layers, as well as UE features and capabilities related to more than 2 UE Tx branches and more than 2 UL MIMO layers are not supported by RedCap UEs;
CA, MR-DC, dual active protocol stacks (DAPS), conditional PSCell addition and change (CPAC) and integrated access and backhaul (IAB) (i.e., the RedCap UE is not expected to act as IAB node) related UE features and corresponding capabilities are not supported by RedCap UEs. All other feature groups or components of the feature groups as well as capabilities remain applicable for RedCap UEs same as non-RedCap UEs, unless indicated otherwise.

A redcap UE specific initial DL BWP (initialDownlinkBWP-RedCap) is introduced in addition to initial DL BWP (initialDownlinkBWP). A redcap UE specific initial UL BWP (initialUplinkBWP-RedCap) is also introduced in addition to initial UL BWP (initialUplinkBWP). initialDownlinkBWP-RedCap and initialUplinkBWP-RedCap can be optionally signaled by gNB in SIB1. In the RRC_IDLE.

Meanwhile, for small data transmission, CG resources for SDT are configured in RRCRelease message for NUL and/or SUL. The SUL CG resources configured for SDT in RRCRelease are for PUSCH transmissions in InitialUplinkBWP. The assumption is that initialUplinkBWP-Redcap is not supported for SUL.

The NUL CG resources configured for SDT in RRCRelease are for PUSCH transmissions in InitialUplinkBWP if UE is non RedCap UE. For a RedCap UE:
If initialUplinkBWP-Redcap is configured/signaled by gNB (e.g. in SI) for NUL, the NUL CG resources configured for SDT in RRCRelease are for PUSCH transmissions in initialUplinkBWP-Redcap of NUL. If initialUplinkBWP-Redcap is not configured/signaled by gNB (e.g. in SI) for NUL, the NUL CG resources configured for SDT in RRCRelease are for PUSCH transmissions in initialUplinkBWP of NUL.

When CG-SDT procedure is initiated for SDT:
For the selected uplink carrier for SDT, if initialUplinkBWP-Redcap is configured, UL transmission during SDT procedure is over initialUplinkBWP-Redcap. Otherwise, UL transmission during SDT procedure is over initialUplinkBWP
If initialDownlinkBWP-Redcap is configured, DL reception during SDT procedure is over initialDownlinkBWP-Redcap. Otherwise, DL reception is over initialDownlinkBWP.

Within the frequency span of a carrier, multiple SSBs can be transmitted. The physical cell identifiers (PCIs) of SSBs transmitted in different frequency locations do not have to be unique, i.e. different SSBs in the frequency domain can have different PCIs. However, when an SSB is associated with an remaining system information (RMSI), the SSB is referred to as a Cell-Defining SSB (CD-SSB). Cell defining SSB (CD-SSB) may or may not be located within initialDownlinkBWP-Redcap. If initialDownlinkBWP-Redcap is configured and CD-SSB is not located within initialDownlinkBWP-Redcap, A) UE needs to measure SSB over initialDownlinkBWP for CG resource selection; B) UE needs to also monitor DL over initialDownlinkBWP-Redcap for PDCCH reception. The issue is that UE cannot perform both A) and B) concurrently and hence CG-SDT procedure does not operate as intended and enhancements are needed.

### Embodiment 1—CG-SDT for Redcap Specific Initial BWP

### [Method 1-1]

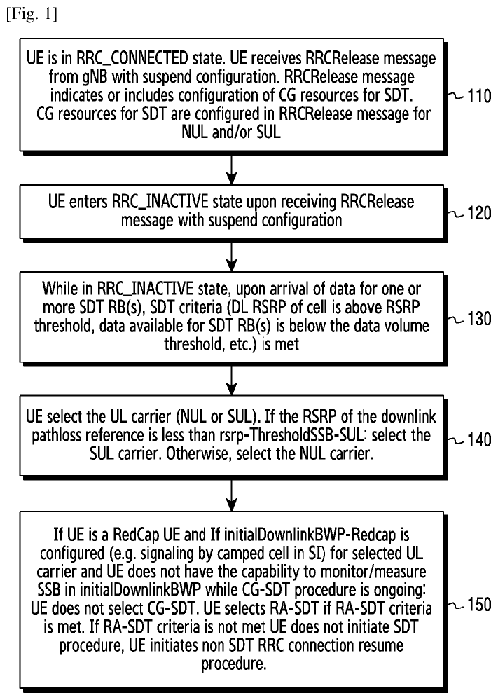

FIG. 1 illustrates an example of configured grant (CG) SDT procedure in accordance with an embodiment of the disclosure.

In an embodiment of this disclosure, operation is as follows:
UE is in RRC_CONNECTED state. In the RRC_CONNECTED state, one or more serving cell(s) can be configured. Serving cell(s) are grouped in one or more timing advanced groups (TAGs). UE maintains separate UL timing for each TAG. TimeAlignmentTimer is maintained per TAG. The value of TimeAlignmentTimer for each TAG is signaled by gNB in RRCReconfiguration message. At the time of connection setup/resume the value of TimeAlignmentTimer signaled in system information is used.
Operation 110: While the UE is in RRC_CONNECTED state, UE receives RRCRelease message from gNB with suspend configuration. RRCRelease message indicates or includes configuration of CG resources for SDT. CG resources for SDT are configured in RRCRelease message for NUL and/or SUL. RRCRelease message indicates or includes cg-SDT-TimeAlignmentTimer value.
Operation 120: UE enters RRC_INACTIVE state upon receiving RRCRelease message with suspend configuration. UE stops all the TimeAlignmentTimers running upon transition from RRC_CONNECTED to RRC_INACTIVE. UE starts the cg-SDT-TimeAlignmentTimer upon transition from RRC_CONNECTED to RRC_INACTIVE if the RRCRelease message includes CG-SDT configuration or configuration of CG resources for SDT. The value of this timer is received in RRCRelease message.
Operation 130: While in RRC_INACTIVE state, upon arrival of data for one or more SDT RB(s), SDT criteria (DL RSRP of cell is above RSRP threshold, data available for SDT RB(s) is below the data volume threshold, etc.) is met. UE select the UL carrier (NUL or SUL).
Operation 140: If the RSRP of the downlink pathloss reference is less than rsrp-ThresholdSSB-SUL: UE selects the SUL carrier. Otherwise, UE selects the NUL carrier.
   (Cond X) If UE is a RedCap UE and If initialDownlinkBWP-Redcap is configured (e.g. signaling by camped cell in SI) for selected UL carrier and CD-SSB (or non-CD-SSB (NCD-SSB) or both CD-SSB and NCD-SSB) is not located in the initialDownlinkBWP-Redcap and UE does not have the capability to monitor/measure SSB in initialDownlinkBWP while CG-SDT procedure is ongoing:
      UE does not select CG-SDT. UE selects RA-SDT if RA-SDT criteria is met. If RA-SDT criteria is not met UE does not initiate SDT procedure, UE initiates non SDT RRC connection resume procedure, as in the operation 150.
   Else (i.e., Cond X is not met i.e. If UE is not a RedCap UE; OR If UE is a RedCap UE and If initialDownlinkBWP-Redcap is not configured for selected UL carrier; OR If UE is a RedCap UE and If initialDownlinkBWP-Redcap is configured for selected UL carrier and CD-SSB (or NCD-SSB or both CD-SSB and NCD-SSB) is not located in the initialDownlinkBWP-Redcap and UE have the capability to monitor/measure SSB in initialDownlinkBWP while CG-SDT procedure is ongoing; OR If UE is a RedCap UE and If initialDownlinkBWP-Redcap is configured for selected UL carrier and CD-SSB (or NCD-SSB or both CD-SSB and NCD-SSB) is located in the initialDownlinkBWP-Redcap):
      UE select CG-SDT if CG-SDT criteria is met. If CG-SDT criteria is not met, UE selects RA-SDT if RA-SDT criteria is met. If RA-SDT criteria is not met, UE does not initiate SDT procedure, UE initiates non SDT RRC connection resume procedure.

### [Method 1-2]

### Alternate:

(Cond Y) If UE is a RedCap UE and selected UL carrier is SUL and If initialDownlinkBWP-Redcap is configured (e.g. signaling by camped cell in SI) for selected UL carrier and CD-SSB (or NCD-SSB or both CD-SSB and NCD-SSB) is not located in the initialDownlinkBWP-Redcap and UE does not have the capability to monitor/measure SSB in initialDownlinkBWP while CG-SDT procedure is ongoing:
   UE does not select CG-SDT. UE selects RA-SDT if RA-SDT criteria is met. If RA-SDT criteria is not met UE does not initiate SDT procedure, UE initiates non SDT RRC connection resume procedure.
Else (i.e. cond Y is not met i.e. if selected UL carrier is NUL; If UE is not a RedCap UE; OR If UE is a RedCap UE and selected UL carrier is SUL and If initialDownlinkBWP-Redcap is not configured for selected UL carrier; OR If UE is a RedCap UE and selected UL carrier is SUL and If initialDownlinkBWP-Redcap is configured for selected UL carrier and UE have the capability to monitor/measure SSB in initialDownlinkBWP while CG-SDT procedure is ongoing; OR If UE is a RedCap UE and selected UL carrier is SUL and If initialDownlinkBWP-Redcap is configured for selected UL carrier and CD-SSB (or NCD-SSB or both CD-SSB and NCD-SSB) is located in the initialDownlinkBWP-Redcap)
   UE select CG-SDT if CG-SDT criteria is met. If CG-SDT criteria is not met, UE selects RA-SDT if RA-SDT criteria is met. If RA-SDT criteria is not met, UE does not initiate SDT procedure, UE initiates non SDT RRC connection resume procedure.

When CG-SDT procedure is initiated for SDT and UE is a RedCap UE:
For the selected uplink carrier for SDT, if initialUplinkBWP-Redcap is configured, UL transmission during SDT procedure is over initialUplinkBWP-Redcap. Otherwise, UL transmission during SDT procedure is over initialUplinkBWP.
If initialDownlinkBWP-Redcap is configured, DL reception during SDT procedure is over initialDownlinkBWP-Redcap. Otherwise, DL reception is over initialDownlinkBWP.

Criteria for selecting CG-SDT: CG-SDT criteria is considered met, if all of the following conditions are met,
1> if CG-SDT is configured on the selected UL carrier, and TA of the configured grant Type 1 resource is valid in the first available CG occasion; and
1> if, for each RB having data available for transmission, configured-GrantType1Allowed, if configured, is configured with value true for the corresponding logical channel; and
2> if at least one SSB configured for CG-SDT with SS-RSRP above cg-SDT-RSRP-ThresholdSSB is available:

### [Method 2-1]

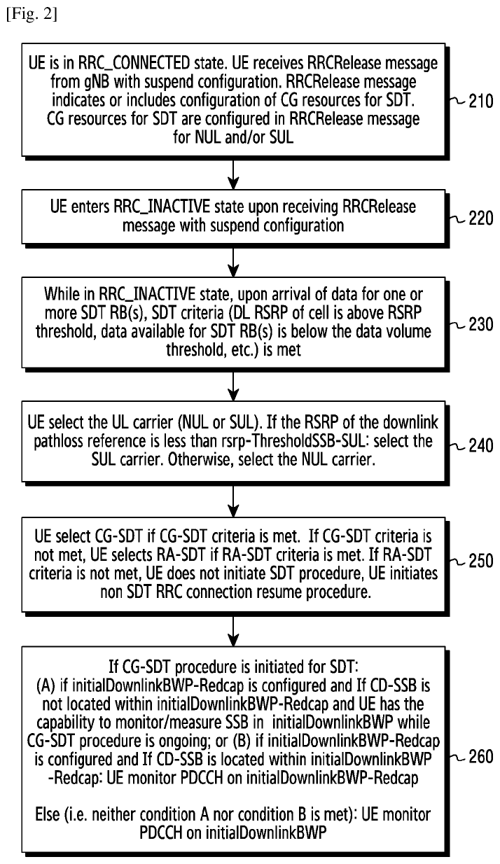

FIG. 2 illustrates another example of CG-SDT procedure in accordance with an embodiment of the disclosure.

In an embodiment of this disclosure, operation is as follows:
UE is in RRC_CONNECTED state. In the RRC_CONNECTED state, one or more serving cell(s) can be configured. Serving cell(s) are grouped in one or more timing advanced groups. UE maintains separate UL timing for each TAG. TimeAlignmentTimer is maintained per TAG. The value of TimeAlignmentTimer for each TAG is signaled by gNB in RRCReconfiguration message. At the time of connection setup/resume the value of TimeAlignmentTimer signaled in system information is used.
Operation 210: While the UE is in RRC_CONNECTED state, UE receives RRCRelease message from gNB with suspend configuration. RRCRelease message indicates or includes configuration of CG resources for SDT. CG resources for SDT are configured in RRCRelease message for NUL and/or SUL. RRCRelease message indicates or includes cg-SDT-TimeAlignmentTimer value.
Operation 220: UE enters RRC_INACTIVE state upon receiving RRCRelease message with suspend configuration. UE stops all the TimeAlignmentTimers running upon transition from RRC_CONNECTED to RRC_INACTIVE. UE starts the cg-SDT-TimeAlignmentTimer upon transition from RRC_CONNECTED to RRC_INACTIVE if the RRCRelease message includes CG-SDT configuration or configuration of CG resources for SDT. The value of this timer is received in RRCRelease message.
Operation 230: While in RRC_INACTIVE state, upon arrival of data for one or more SDT RB(s), SDT criteria (DL RSRP of cell is above RSRP threshold, data available for SDT RB(s) is below the data volume threshold, etc.) is met.
Operation 240: UE select the UL carrier (NUL or SUL). If the RSRP of the downlink pathloss reference is less than rsrp-ThresholdSSB-SUL: select the SUL carrier. Otherwise, select the NUL carrier.
Operation 250: UE select CG-SDT if CG-SDT criteria is met. If CG-SDT criteria is not met, UE selects RA-SDT if RA-SDT criteria is met. If RA-SDT criteria is not met, UE does not initiate SDT procedure, UE initiates non SDT RRC connection resume procedure.
Operation 260: If CG-SDT procedure is initiated for SDT:
   (A) if UE is a RedCap UE and if initialDownlinkBWP-Redcap is configured and If CD-SSB (or SSB or both CD-SSB and NCD-SSB) is not located within initialDownlinkBWP-Redcap and UE has the capability to monitor/measure SSB in initialDownlinkBWP while CG-SDT procedure is ongoing; or
   (B) if UE is a RedCap UE and if initialDownlinkBWP-Redcap is configured and If CD-SSB (or NCD-SSB) is located within initialDownlinkBWP-Redcap:
      UE monitor PDCCH on initialDownlinkBWP-Redcap
   Else (i.e. neither condition A nor condition B is met)
      UE monitor PDCCH on initialDownlinkBWP

### [Method 2-2]

Alternate:
If CG-SDT procedure is initiated for SDT:
   if UE is a RedCap UE and if initialDownlinkBWP-Redcap is configured and If CD-SSB (or NCD-SSB) is located within initialDownlinkBWP-Redcap:
      UE monitor PDCCH on initialDownlinkBWP-Redcap
   Else
      UE monitor PDCCH on initialDownlinkBWP

For the selected uplink carrier for SDT, if initialUplinkBWP-Redcap is configured, UL transmission during SDT procedure is over initialUplinkBWP-Redcap. Otherwise, UL transmission during SDT procedure is over initialUplinkBWP.

Criteria for selecting CG-SDT: CG-SDT criteria is considered met, if all of the following conditions are met,
1> if CG-SDT is configured on the selected UL carrier, and TA of the configured grant Type 1 resource is valid in the first available CG occasion; and
1> if, for each RB having data available for transmission, configured-GrantType1Allowed, if configured, is configured with value true for the corresponding logical channel; and
2> if at least one SSB configured for CG-SDT with SS-RSRP above cg-SDT-RSRP-ThresholdSSB is available:

### [Method 3]

In an embodiment of this disclosure, operation is as follows:
Step 0: UE is in RRC_CONNECTED state. In the RRC_CONNECTED state, one or more serving cell(s) can be configured. Serving cell(s) are grouped in one or more timing advanced groups. UE maintains separate UL timing for each TAG. TimeAlignmentTimer is maintained per TAG. The value of TimeAlignmentTimer for each TAG is signaled by gNB in RRCReconfiguration message. At the time of connection setup/resume the value of TimeAlignmentTimer signaled in system information is used.
Step 1: While the UE is in RRC_CONNECTED state, UE receives RRCRelease message from gNB with suspend configuration. RRCRelease message indicates or includes configuration of CG resources for SDT. CG resources for SDT are configured in RRCRelease message for NUL and/or SUL. RRCRelease message indicates or includes cg-SDT-TimeAlignmentTimer value.
Step 2: UE enters RRC_INACTIVE state upon receiving RRCRelease message with suspend configuration. UE stops all the TimeAlignmentTimers running upon transition from RRC_CONNECTED to RRC_INACTIVE. UE starts the cg-SDT-TimeAlignmentTimer upon transition from RRC_CONNECTED to RRC_INACTIVE if the RRCRelease message includes CG-SDT configuration or configuration of CG resources for SDT. The value of this timer is received in RRCRelease message.
Step 3: While in RRC_INACTIVE state, upon arrival of data for one or more SDT RB(s), SDT criteria (DL RSRP of cell is above RSRP threshold, data available for SDT RB(s) is below the data volume threshold, etc.) is met. UE select the UL carrier (NUL or SUL). If the RSRP of the downlink pathloss reference is less than rsrp-ThresholdSSB-SUL: select the SUL carrier. Otherwise, select the NUL carrier.
   UE select CG-SDT if CG-SDT criteria is met. If CG-SDT criteria is not met, UE selects RA-SDT if RA-SDT criteria is met. If RA-SDT criteria is not met, UE does not initiate SDT procedure, UE initiates non SDT RRC connection resume procedure.
   When CG-SDT procedure is initiated for SDT and UE is a RedCap UE:
      For the selected uplink carrier for SDT, if initialUplinkBWP-Redcap is configured, UL transmission during SDT procedure is over initialUplinkBWP-Redcap. Otherwise, UL transmission (e.g. PUSCH, PUCCH) during SDT procedure is over initialUplinkBWP
      If initialDownlinkBWP-Redcap is configured, DL reception (e.g. PDSCH) during SDT procedure is over initialDownlinkBWP-Redcap. Otherwise, DL reception is over initialDownlinkBWP.
      If initialDownlinkBWP-Redcap is configured and If CD-SSB (or no SSB or both CD-SSB and NCD-SSB) is not located in initialDownlinkBWP-Redcap:
         UE monitor/measure SSB in initialDownlinkBWP
         If the PDCCH monitoring occasions for monitoring PDCCH addressed to C-RNTI/CS-RNTI on initialDownlinkBWP-Redcap overlaps in time with SSBs in initialDownlinkBWP, UE can skip monitoring PDCCH on initialDownlinkBWP-Redcap while monitoring/measuring SSBs in initialDownlinkBWP

Criteria for selecting CG-SDT: CG-SDT criteria is considered met, if all of the following conditions are met,
1> if CG-SDT is configured on the selected UL carrier, and TA of the configured grant Type 1 resource is valid in the first available CG occasion; and
1> if, for each RB having data available for transmission, configured-GrantType1Allowed, if configured, is configured with value true for the corresponding logical channel; and
2> if at least one SSB configured for CG-SDT with SS-RSRP above cg-SDT-RSRP-ThresholdSSB is available

In an embodiment while the UE is in RRC_CONNECTED state, it can inform gNB whether it supports NCD-SSB in RRC_INACTIVE state (or whether it supports NCD-SSB in RRC_INACTIVE state for SDT or whether it supports NCD-SSB in RRC_INACTIVE/Idle). UE can inform this using UE capability information message. While the UE is in RRC_CONNECTED state, gNB sends RRCRelease message from gNB with suspend configuration to switch UE to RRC_INACTIVE state.
If initialDownlinkBWP-Redcap is configured for serving cell (i.e. PCell) and CD-SSB is not located in initialDownlinkBWP-Redcap:
   If UE supports NCD-SSB in RRC_INACTIVE state (or it supports NCD-SSB in RRC_INACTIVE state for SDT or it supports NCD-SSB in RRC_INACTIVE/Idle), gNB can configure NCD-SSB for initialDownlinkBWP-Redcap in RRCRelease message (or in SI) and include configuration of CG resources for SDT in RRCRelease message
      In this case when CG-SDT is initiated, UE can measure/monitor SSB in initial-DownlinkB WP-Redcap
   If UE does not supports NCD-SSB, gNB does not include configuration of CG resources for SDT in RRCRelease message
Else:
   gNB can include configuration of CG resources for SDT in RRCRelease message
   In this case when CG-SDT is initiated, UE can measure/monitor SSB in initialDownlinkBWP-Redcap, if initialDownlinkBWP-Redcap is configured.

In the above description ‘configured’ may mean signalled by gNB in system information or signalling message.

### Embodiment 2—DCCH & DTCH in MsgB/Msg4

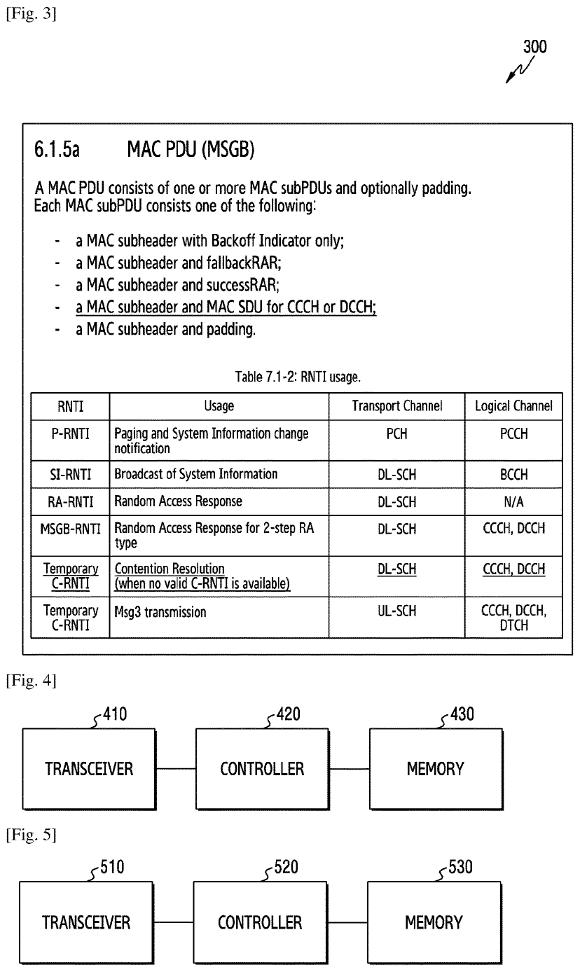

FIG. 3 illustrates an example of MAC PDU and RNTI usage in accordance with an embodiment of the disclosure.

As per the latest MAC specification, only CCCH or DCCH MAC PDU can be included in MsgB/Msg4 during the RA-SDT procedure based on 2 step RA and 4 step RA respectively, as in the FIG. 3.

Inclusion of DTCH MAC SDU in MsgB/Msg4 can save additional PDCCH transmission by gNB and HARQ feedback transmission by UE. If inclusion of DTCH MAC SDU in MsgB/Msg4 is allowed, DCCH and DTCH can be included together in MsgB/Msg4. For example, when there is no subsequent UL data and network has only one DTCH MAC SDU to be transmitted, network can send RRCRelease together with the DTCH MAC SDU in MsgB/Msg4 in response to MsgA/Msg3 during RA procedure initiated for SDT. The order in which DCCH and DTCH needs to be multiplexed in MsgB/Msg4 MAC PDU needs to be specified to ensure that RRCRelease is not processed before the DTCH MAC SDU. If RRCRelease is processed before the DTCH MAC SDU, content of DTCH MAC SDU will be discarded as radio bearers (RBs) will be suspended upon processing of RRCRelease message.

In an embodiment of this disclosure, during the random access procedure initiated for SDT (i.e., RA-SDT), DCCH and DTCH are not multiplexed together in Msg4/MsgB MAC PDU. If gNB has both DCCH and DTCH MAC SDU available, gNB includes DTCH MAC SDU in Msg4/MsgB MAC PDU wherein Msg4/MsgB are transmitted by gNB in response to reception of Msg4/MsgA.

In an embodiment of this disclosure, during the random access procedure initiated for SDT (i.e., RA-SDT), DCCH MAC SDU including RRCRelease message and DTCH MAC SDU are not multiplexed together in Msg4/MsgB MAC PDU. If gNB has both DCCH MAC SDU including RRCRelease message and DTCH MAC SDU available, gNB includes DTCH MAC SDU in Msg4/MsgB MAC PDU wherein Msg4/MsgB are transmitted by gNB in response to reception of Msg4/MsgA.

In an embodiment of this disclosure, during the random access procedure initiated for SDT (i.e., RA-SDT), DCCH and DTCH can be multiplexed together in Msg4/MsgB MAC PDU. If gNB has both DCCH and DTCH MAC SDU available, gNB includes DTCH MAC SDU before DCCH MAC SDU in Msg4/MsgB MAC PDU wherein Msg4/MsgB are transmitted by gNB in response to reception of Msg4/MsgA.

In an embodiment of this disclosure, during the random access procedure initiated for SDT (i.e., RA-SDT), DCCH and DTCH can be multiplexed together in Msg4/MsgB MAC PDU. If gNB has both DCCH MAC SDU including RRCRelease message and DTCH MAC SDU available, gNB includes DTCH MAC SDU before DCCH MAC SDU MAC SDU including RRCRelease message in Msg4/MsgB MAC PDU wherein Msg4/MsgB are transmitted by gNB in response to reception of Msg4/MsgA.

In an embodiment of this disclosure, during the random access procedure initiated for SDT (i.e., RA-SDT), if UE receives both DCCH MAC SDU and DTCH MAC SDU in Msg4/MsgB, UE shall first process the DTCH MAC SDU first.

In an embodiment while the UE is in RRC_CONNECTED state, it can inform gNB whether it supports multiplexing of DCCH and DTCH in Msg4/MsgB MAC PDU. GNB can multiplex DCCH and DTCH in Msg4/MsgB MAC PDU during SDT only if UE has indicated support.

FIG. 4 is a block diagram of a terminal according to an embodiment of the disclosure.

Referring to FIG. 4, a terminal includes a transceiver 410, a controller 420 and a memory 430. The controller 420 may refer to a circuitry, an application-specific integrated circuit (ASIC), or at least one processor. The transceiver 410, the controller 420 and the memory 430 are configured to perform the operations of the UE illustrated in the figures, e.g., FIGS. 1 to 3, or described above. Although the transceiver 410, the controller 420 and the memory 430 are shown as separate entities, they may be realized as a single entity like a single chip. Or, the transceiver 410, the controller 420 and the memory 430 may be electrically connected to or coupled with each other.

The transceiver 410 may transmit and receive signals to and from other network entities (e.g., a base station or another terminal).

The controller 420 may control the UE to perform functions according to one of the embodiments described above.

In an embodiment, the operations of the terminal may be implemented using the memory 430 storing corresponding program codes. Specifically, the terminal may be equipped with the memory 430 to store program codes implementing desired operations. To perform the desired operations, the controller 420 may read and execute the program codes stored in the memory 430 by using a processor or a central processing unit (CPU).

FIG. 5 is a block diagram of a base station according to an embodiment of the disclosure.

Referring to FIG. 5, a base station includes a transceiver 510, a controller 520 and a memory 530. The transceiver 510, the controller 520 and the memory 530 are configured to perform the operations of the network (e.g., gNB) illustrated in the figures, e.g., FIGS. 1 to 3, or described above. Although the transceiver 510, the controller 520 and the memory 530 are shown as separate entities, they may be realized as a single entity like a single chip. The transceiver 510, the controller 520 and the memory 530 may be electrically connected to or coupled with each other.

The transceiver 510 may transmit and receive signals to and from other network entities, e.g., a terminal. The controller 520 may control the base station to perform functions according to one of the embodiments described above. The controller 520 may refer to a circuitry, an ASIC, or at least one processor. In an embodiment, the operations of the base station may be implemented using the memory 530 storing corresponding program codes. Specifically, the base station may be equipped with the memory 530 to store program codes implementing desired operations. To perform the desired operations, the controller 520 may read and execute the program codes stored in the memory 530 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving, from a base station, a radio resource control (RRC) release message including suspend configuration, the RRC release message including information on a configured grant (CG) resource for a small data transmission (SDT);
identifying an uplink carrier for an SDT data based on an SDT criteria being met;
identifying a SDT procedure for the SDT data among a CG-SDT procedure and a random access (RA)-SDT procedure; and
transmitting, to the base station, the SDT data on the uplink carrier according to the SDT procedure.

2. The method of claim 1, wherein the identifying of the SDT procedure further comprises:
in case that the terminal is a reduced capability terminal, a first initial downlink bandwidth part (BWP) for the reduced capability terminal is configured for the uplink carrier, and the terminal does not have a capability for monitoring a synchronization signal and physical broadcast block (SSB) in a second initial downlink BWP while the CG-SDT procedure is ongoing, selecting the RA-SDT procedure based on an RA-SDT criteria being met.

3. The method of claim 2, wherein the RA-SDT procedure is selected, in case that a cell defining SSB (CD-SSB) is not located in the first initial downlink BWP for the reduced capability terminal.

4. The method of claim 2, wherein, in case that the RA-SDT criteria is not met, an SDT procedure is not initiated and the SDT data is transmitted according to a non-SDT RRC resume procedure.

5. The method of claim 1, wherein the identifying of the SDT procedure further comprises:
in case that the terminal is not a reduced capability terminal, a first initial downlink BWP for the reduced capability terminal is not configured for the uplink carrier, or the terminal has a capability for monitoring a SSB in a second initial downlink BWP while the CG-SDT procedure is ongoing, selecting the CG-SDT procedure based on an CG-SDT criteria being met.

6. The method of claim 5, wherein the CG-SDT procedure is selected, in case that a CD-SSB is located in the first initial downlink BWP for the reduced capability terminal.

7. The method of claim 5, wherein, in case that the CG-SDT criteria is not met, the RA-SDT procedure is selected based on an RA-SDT criteria being met, and
wherein, in case that the RA-SDT criteria is not met, an SDT procedure is not initiated and the SDT data is transmitted according to a non-SDT RRC resume procedure.

8. The method of claim 1, wherein the uplink carrier is a normal uplink (NUL) carrier or a supplementary uplink (SUL) carrier.

9. A terminal in a wireless communication system, the terminal comprising:
a transceiver; and
a controller coupled with the transceiver and configured to:
receive, from a base station, a radio resource control (RRC) release message including suspend configuration, the RRC release message including information on a configured grant (CG) resource for a small data transmission (SDT),
identify an uplink carrier for an SDT data based on an SDT criteria being met,
identify a SDT procedure for the SDT data among a CG-SDT procedure and a random access (RA)-SDT procedure, and
transmit, to the base station, the SDT data on the uplink carrier according to the SDT procedure.

10. The terminal of claim 9, wherein the uplink carrier is a NUL carrier or a SUL carrier, and
wherein the controller is further configured to:
in case that the terminal is a reduced capability terminal, a first initial downlink bandwidth part (BWP) for the reduced capability terminal is configured for the uplink carrier, and the terminal does not have a capability for monitoring a synchronization signal and physical broadcast block (SSB) in a second initial downlink BWP while the CG-SDT procedure is ongoing, select the RA-SDT procedure based on an RA-SDT criteria being met.

11. The terminal of claim 10, wherein the RA-SDT procedure is selected, in case that a cell defining SSB (CD-SSB) is not located in the first initial downlink BWP for the reduced capability terminal.

12. The terminal of claim 10, wherein, in case that the RA-SDT criteria is not met, an SDT procedure is not initiated and the SDT data is transmitted according to a non-SDT RRC resume procedure.

13. The terminal of claim 9, wherein the controller is further configured to: in case that the terminal is not a reduced capability terminal, a first initial downlink BWP for the reduced capability terminal is not configured for the uplink carrier, or the terminal has a capability for monitoring a SSB in a second initial downlink BWP while the CG-SDT procedure is ongoing, select the CG-SDT procedure based on an CG-SDT criteria being met.

14. The terminal of claim 13, wherein the CG-SDT procedure is selected, in case that a CD-SSB is located in the first initial downlink BWP for the reduced capability terminal.

15. The terminal of claim 13, wherein, in case that the CG-SDT criteria is not met, the RA-SDT procedure is selected based on an RA-SDT criteria being met, and
wherein, in case that the RA-SDT criteria is not met, an SDT procedure is not initiated and the SDT data is transmitted according to a non-SDT RRC resume procedure.
